(19) United States
(12) Patent Application Publication
(10) Pub. No.: US 2015/0312679 A1
(43) Pub. Date: Oct. 29, 2015

(54) LOUDSPEAKER WITH TWO MOTORS AND ONE SUSPENSION

(71) Applicant: Richard LITTLE, (US)

(72) Inventor: Richard LITTLE, Huizhou (CN)

(21) Appl. No.: 14/647,901

(22) PCT Filed: Nov. 30, 2012
(86) PCT No.: PCT/CN2012/085656

§ 371 Date: May 28, 2015

(51) Int. Cl. H04R 7/16; H04R 1/00

(52) U.S. Cl. CPC H04R 7/16; H04R 1/00

(57) ABSTRACT

A loudspeaker including a diaphragm, a surround attached to the periphery of the diaphragm, two voice coils attached to the underside of the diaphragm and suspended within corresponding magnetic motors, and a frame that all components are attached to, such that there is no other suspension element in this design, maximizing the excursion capability of the diaphragm to be the clearance between the diaphragm and the motors where, the overall depth of the loudspeaker can be below 13 mm and the operating bandwidth of the loudspeaker extends below 400 Hz.

### FIELD OF THE INVENTION

The present invention relates to loudspeakers, and more particularly, to loudspeakers with one suspension element.

### BACKGROUND OF THE INVENTION

Moving coil loudspeakers that are designed to reproduce low frequency sound typically have two suspension elements, suspending the voice coil inside the motor components, and suspending the diaphragm. The diaphragm, connected to the voice coil by a mechanical joint, is the component of the loudspeaker which creates the outgoing pressure wave. To fit into narrow locations, the normally round shape of the diaphragm is lengthened, from the normally round or circular shape, into an elliptical, racetrack, or rectangular shape. The narrowness of the elliptical shape restricts the suspension system stiffness, as does the need for two suspension elements to control the motion of the voice coil. The conventional loudspeaker design has one of the suspension elements attached to the voice coil, underneath the diaphragm, and this restricts the excursion capability, or maximum moving distance, of the diaphragm to effectively be equal to the vertical distance between the motor and the lower suspension element.

In a typical loudspeaker shown in FIG. 6, the voice coil 7 is attached to a diaphragm 1 and a spider 9. The diaphragm 1 in turn is attached to a surround 2. The spider 9 and surround 2 are suspension elements, and play the role of suspending the diaphragm in the front end of the loudspeaker, and the voice coil within the gap of the magnetic motor structure defined by the top plate 4, magnet 5, and yoke 6. The motor components, spider 9, and surround 2 are physically connected and supported by a frame 3.

The loudspeaker function is characterized by the response of the voice coil to an electrical input signal, which results in a force being generated on the voice coil along the direction of the voice coil axis, due to the magnetic forces acting upon the voice coil. The force causes the voice coil to move, which causes the diaphragm also to move in the same direction, which pushes on the air in front of the loudspeaker. Thus, an outgoing pressure wave is created from the motion of the coil and diaphragm.

The operating bandwidth of the loudspeaker is controlled at the lower limit by the mass of the moving components, and the stiffness of the suspension elements, which in combination produce the primary mechanical resonance of the moving components, at a frequency known as the primary resonant frequency. This is illustrated in FIG. 7, which is an illustrated graph showing sound pressure level measured as produced by a loudspeaker for a given input signal, in which 1 W means 1 watt, the amount of electrical power input into the loudspeaker and 1 m means 1 meter, the distance from the driver at which the measurement is taken, by referring to frequency f₀ and arrow (a) in the figure. The frequency f₀ can be adjusted downwards by decreasing the stiffness of the suspension elements in the loudspeaker, or by increasing the mass of the moving components in the loudspeaker.

The upper bandwidth limit in a loudspeaker is controlled by either the voice coil's inductance, which at high frequencies presents added impedance to the input signal, or the break-up modes of the diaphragm. Break-up refers to the non-pistonic behavior of the diaphragm. At higher frequencies, the diaphragm may flex in a resonant response to the input signal, with parts of the diaphragm moving out of phase with other parts, and this results in a loss of output sound pressure level. This is illustrated in FIG. 7, which shows sound pressure level for a given input signal level. The sound pressure level curve shows a loss of output due to break-up at frequency f₁.

It is often desirable to have the bandwidth to extend to as low a frequency as possible, and to cover as much as possible the range of human hearing. For small loudspeakers, the mass of the moving components is often very light, so reducing the stiffness can offer the best opportunity to reduce the lower bandwidth cutoff frequency, and extend the bandwidth. The ability to lower the stiffness is limited by the presence of the two suspension elements (spider and surround), as they each contribute some level of stiffness to the suspension system.

Maximum sound pressure output is also limited by the presence of two suspension elements. The outgoing sound pressure wave is created by the motion of the diaphragm; the further the diaphragm can move, the more sound pressure can be generated. The second suspension element, the spider, is typically attached to the voice coil below the diaphragm. Therefore, it is the clearance (distance or gap) between the spider and the motor components which limits the maximum output, and not the clearance between the diaphragm and the motor components.

One example of an improved loudspeaker is shown in FIG. 5. The loudspeaker only features one suspension element, the surround, and thus maximum output of the loudspeaker is instead limited by the clearance between the diaphragm and the motor components. Loudspeakers of this type of design have limitations in their design. To properly control the motion of the voice coil, and keep the motion to be acting substantially in the axial direction, the loudspeaker's diaphragm diameter tends to be small, typically less than 40 mm in diameter. This limits the area of the diaphragm, which also limits the maximum sound pressure level. Loudspeakers of this design, having diameters of 25 mm or less, can typically produce a sound pressure level of 74 dB for a 1 W input, and have resonant frequencies in excess of 400 Hz.

### SUMMARY OF THE INVENTION

The invention provides a loudspeaker which overcomes the deficiencies in the prior art and has a long and narrow structure, compact size, with wide bandwidth to fit into compact space.

A loudspeaker comprising a diaphragm, a surround attached to the periphery of the diaphragm, two voice coils attached to the underside of the diaphragm and suspended within corresponding magnetic motors, and a frame that all components are directly or indirectly attached to.

The shape of the diaphragm, the corresponding surround and the frame are all long and narrow. Described herein as rectangular, it is not specifically limited to be rectangular shape, but may also be other shapes, which can be described effectively as a shape having a long axis and a short axis, e.g., oval or elliptical shape.

Preferably, the shape of the diaphragm is rectangle. The long axis of diaphragm extends from the one short side of the diaphragm to the other short side, in correspondent with the center of the two coils, with a length ranging from 50 mm to 90 mm; The short axis of the diaphragm extends from the one long side of the diaphragm to the other long side, in correspondent with the center of the two coils, with a length ranging from 20 mm to 28 mm.

The design of the frame is to support the motor components and the diaphragm, and to also position electrical terminals, through which the external electrical input signal comes in. Preferably, the frame also features acoustic venting holes on its side or bottom surfaces, so as to prevent the frame from becoming a sealed enclosure for the diaphragm to act upon, which would otherwise prevent the resonant frequency of the loudspeaker from reaching its target. The total area of venting holes should be at least 5% of the surface area of the diaphragm, to avoid significant compression effects and work within the design. The diameter of the venting hole preferably ranges from 8.0 mm to 13.0 mm to fit the design when provided in the bottom surface of the frame.

The design also features lead wires, which is a conventional design that leads from the electrical terminals to the voice coils. This allows for the electrical connection between the voice coils and the external electrical input signal.

The size and design of the voice coils are such that the overall motor force factor (the ratio of the output magnetic force acting upon the coils, to the input current to the coils) is sufficient to produce the required sound pressure level for the end user of the product to hear the product comfortably. The design factor which controls this is the length of voice coil wire placed into the motor gap, where the magnetic field is concentrated. Geometrically, this is set by the voice coils' cylindrical diameter, the wire diameter, and the winding height of the turns of wire. The important factor in the design of the coils is the resulting sound pressure level produced by the loudspeaker, which would be more than 78 dB at a 1 meter distance, for a 1 watt input power level. The two coils may be wired in series or in parallel, as desired by the designer, with wiring connecting the coils to the two electrical terminals. The voice coils is preferably attached to the diaphragm, with their centers positioned along the long axis of the diaphragm, and symmetrically positioned with respect to the short axis of the diaphragm. Preferably, the diameter of the cylinder of the voice coils lies within a range between 8.0 and 13.0 mm. The overall cylinder lateral height of the voice coil should preferably lie between 5 and 7 mm. The two voice coils are positioned along the long axis, 40 mm apart from each other.

The diaphragm is preferably flat, normally with a thickness much less than 1 mm, and preferably ranges from 0.05 mm to 0.20 mm, to maximize the excursion capability of the loudspeaker, given the restrictions on the depth of the loudspeaker. The diaphragm thickness varies with the diaphragm material (aluminum, titanium or other options) and different materials have different thicknesses available, due to the availability of the raw material in sheet foil form. The “much less than 1 mm” relates to the height constraint and the excursion constraint. The thicker the diaphragm is, either the transducer must get taller, or the excursion clearances become less.

Specifically, each magnetic motor comprises a top plate, a magnet and a yoke. In detail, the yoke is a steel component housing a magnet against its lower inner surface; the magnet has placed on its upper surface a steel component known as a top plate; both the top plate and magnet are cylindrical in shape, and the arrangement of the three components is such that there exists an air gap between the outer diameter of the top plate, and the inner cylindrical diameter of the yoke. In this air gap the magnetic flux generated by the magnet, when magnetized, is concentrated. It is in this air gap of the magnetic motor that the voice coil is suspended.

The materials used in the present invention for each component are normal materials as in the prior art.

The replacement of a single motor with two motors does allow the designer the freedom to adjust the motor force produced upon the voice coils upwards or downwards, which changes the level of the sound pressure level frequency response curve shown in FIG. 7 in response to arrow (c), while keeping the motors' dimensions within the confines of the small shape and size of the loudspeaker. The shallow profile and rectangular shape allows the loudspeaker to be located in appliances which have narrow profiles.

Further, with the selection of the components within the loudspeaker fitted within this profile, it is able to extend the range of the resonant frequency, typically to reach a low resonant frequency. The low resonant frequency allows for the production of low frequency sound, from a loudspeaker placed into a location in which a high frequency audio loudspeaker would normally fit.

The loudspeaker comprises two sets of voice coils and two corresponding magnetic motors. This allows for compact motors to be placed within the confines of the loudspeaker size, thus producing enough motor force without making the loudspeaker larger. This also extends the high frequency bandwidth limit, noted as f₁ in FIG. 7, over that experienced with similar loudspeaker designs with flat diaphragms and a single coil. This extension occurs because the length of diaphragm, along the long axis of the loudspeaker, between the two coils, and between each coil and the suspension element at the end of the long axis of the loudspeaker, are all reduced over the design case in which the loudspeaker only has a single voice coil; the reduction in length acts to increase the frequency at which the diaphragm goes into its break-up behavior, thus increasing the bandwidth. Small adjustments to the attachment positions of the voice coils to the diaphragm will adjust the value of f₁, as noted by arrow (b) in FIG. 7.

In the present invention, there is no second suspension element in this design, maximizing the excursion capability of the diaphragm to be the clearance between the diaphragm and motor, and decreasing the overall stiffness of the suspension system of the loudspeaker. The distribution of motors and voice coils along the long axis of the diaphragm allows for the forces imparted by the voice coils to be distributed along the length of the diaphragm. The elongated shape of the loudspeaker allows for an increase in the radiating area of the diaphragm.

With the above structure, the overall depth of the loudspeaker can be below 13 mm and the operating bandwidth of the loudspeaker extends below 400 Hz. Implementations of the invention have been fabricated, and these have been observed to have resonant frequencies at roughly 220 Hz.

The benefit of the invention is to have woofer designs which are shallow in profile, and narrow in profile, while being capable of reproducing sound signals effectively below 400 Hz. Arrays of such products can be deployed into consumer electronics devices such as televisions, computer monitors, and docking stations, all of which are narrow in profile.

### BRIEF DESCRIPTION OF THE DRAWINGS

FIG. 1 is a top angled view of the invention, showing the diaphragm and frame;

FIG. 2 is a bottom angled view of the invention, showing the motors, frame, and terminals;

FIG. 3 is a cutaway view of the invention, through the long axis, showing the motors, voice coils, frame, and diaphragm;

FIG. 4 is an exploded view of the invention, showing all parts;

FIG. 5 is a top angled view of a loudspeaker in prior art which has only one suspension element and one motor, showing the diaphragm and frame;

FIG. 6 is a cutaway view of a loudspeaker in prior art, showing the motor components, coil, frame, diaphragm, spider and dust cap;

FIG. 7 is a graph illustrating concepts in the sound pressure level frequency response and bandwidth of a loudspeaker.

### DETAILED DESCRIPTION OF THE PREFERRED EMBODIMENT

The invention is further described with reference to the drawings.

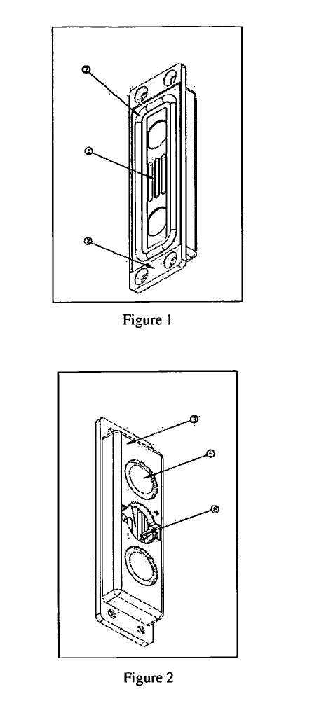

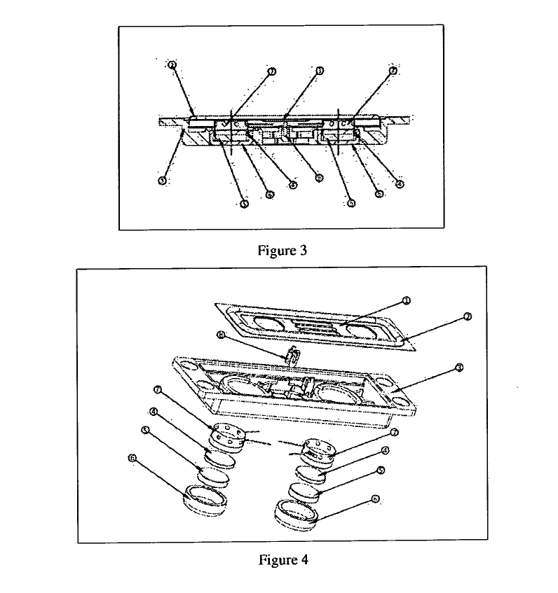

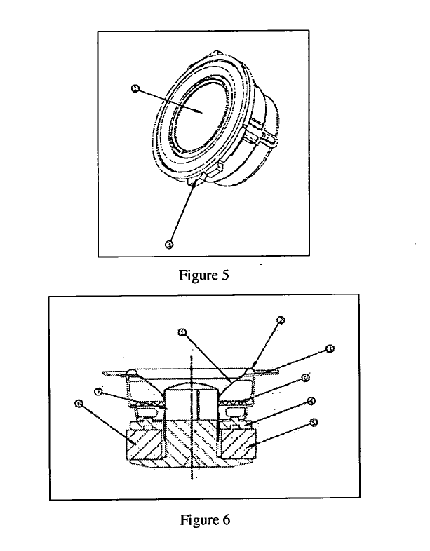

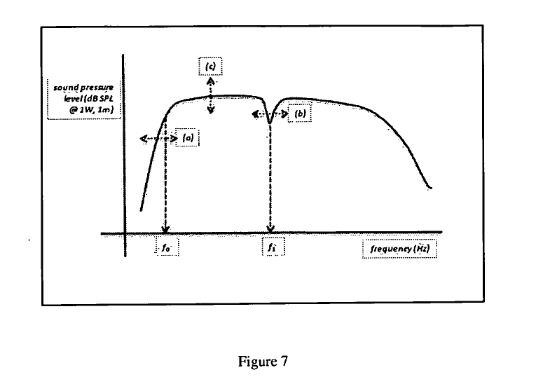

Referring to the diagram of the whole structure of a loudspeaker as shown in FIGS. 1-4, the loudspeaker comprises a flat diaphragm 1, a surround 2 attached to the periphery of the diaphragm 1, two sets of voice coils 7 attached to the underside of the diaphragm 1 and suspended in corresponding magnetic motors comprising a top plate 4, a magnet 5 and a yoke 6, and a frame 3 that all components are attached to.

The long axis of diaphragm 1 extends from the middle of one short side of the diaphragm 1 to the middle of the other short side, in correspondent with the center of the voice coils 7, with a length of 75 mm; The short axis of the diaphragm 1 extends from the middle of one long side of the diaphragm 1 to the middle of the other long side, in correspondent with the center of the voice coils 7, with a length of 24.9 mm.

The diameter of the voice coils 7 is 12 mm and the height of the cylinder lateral surface of the voice coils 7 is 6 mm.

The two voice coils are placed attached to the diaphragm 1, with their centers positioned along the long axis of the diaphragm 1, and symmetrically positioned with respect to the short axis of the diaphragm 1, 40 mm apart.

The frame is provided with venting holes with a 12 mm diameter placed in the bottom, electrical terminals 8 and lead wires to connect the electrical terminals 8 with the voice coils.

The magnetic motors contain magnetic fluid present for the cooling of the voice coils 7.

With the above structure, the overall depth of the loudspeaker is 11 mm, and the operating bandwidth of the loudspeaker extends from 220 Hz to 1 kHz.

1. A loudspeaker comprising:
a diaphragm,
a surround attached to a periphery of the diaphragm, two voice coils attached to an underside of the diaphragm and suspended in corresponding magnetic motors, and
a frame,
wherein the diaphragm, surround, and two voice coils are directly or indirectly attached to the frame.

2. The loudspeaker according to claim 1, wherein the diaphragm is long and narrow with a long axis ranging from 50 mm to 90 mm, and a short axis ranging from 20 mm to 28 mm.

3. The loudspeaker according to claim 1, wherein the loudspeaker comprises venting holes placed in a bottom or side surfaces of the frame.

4. The loudspeaker according to claim 3, wherein an area of the venting hole is at least 5% of the surface area of the diaphragm.

5. The loudspeaker according to claim 4, wherein the venting holes are placed in the bottom surface of the frame and a diameter of the venting holes ranges from 8.0 mm to 13.0 mm.

6. The loudspeaker according to claim 1, wherein the two voice coils are attached to the diaphragm and wherein centers of the voice coils are positioned along a long axis of the diaphragm and symmetrically positioned with respect to a short axis of the diaphragm.

7. The loudspeaker according to claim 6, wherein the two voice coils are arranged 40 mm apart from each other.

8. The loudspeaker according to claim 1, wherein a diameter of a cylinder of the voice coils ranges from 8.0 mm to 13.0 mm.

9. The loudspeaker according to claim 1, wherein an overall cylinder lateral height of the voice coils ranges from 5 mm to 7 mm.

10. The loudspeaker according to claim 1, wherein the diaphragm is flat.

11. The loudspeaker according to claim 10, wherein a thickness of the diaphragm ranges from 0.05 mm to 0.20 mm.

12. The loudspeaker according to claim 1, wherein each of the magnetic motors comprises a top plate, a magnet and a yoke.

13. The loudspeaker according to claim 1, wherein an overall depth of the loudspeaker is less than 13 mm.

14. The loudspeaker according to claim 1, wherein an operating bandwidth of the loudspeaker extends below 400 Hz.

15. The loudspeaker according to claim 1, wherein the magnetic motors contain magnetic fluid present for cooling the voice coils.

16. The loudspeaker according to claim 1, wherein the loudspeaker further comprises electrical terminals placed in the frame and lead wires to connect the electrical terminals with the voice coils.
